(19) United States
(12) Patent Application Publication
(10) Pub. No.: US 2019/0154331 A1
(43) Pub. Date: May 23, 2019

(54) Method And System For At Least Partially Converting Methane-Containing Gas, In Particular Boil-Off Gas, Retained In A Container, To A Liquid State

(71) Applicant: LIQAL B.V., RR BREDA (NL)

(72) Inventors: JEROEN DE PATER, RR BREDA (NL); JORG RAVEN, RR BREDA, NJ (US)

(73) Assignee: LIQAL B.V., RR BREDA (NL)

(21) Appl. No.: 16/306,746

(22) PCT Filed: Jun. 1, 2017
(86) PCT No.: PCT/NL2017/050356

§ 371 Date: Dec. 3, 2018

(30) Foreign Application Priority Data
Jun. 10, 2016 (NL) 2016938

(51) Int. Cl. F25J 1/00; F25J 1/02

(52) U.S. Cl. CPC F25J 1/0025; F25J 1/004; F25J 1/0204; F25J 1/0254; F25J 1/0258; F25J 2290/62; F25J 2230/08; F25J 2230/30; F25J 2240/40; F25J 2270/90; F17C 2265/03

(57) ABSTRACT

Method for at least partially converting methane-containing gas, in particular boil-off gas, retained in a container, to a liquid state, the method comprising the subsequent steps of:
feeding methane-containing gas from said container to a compressor, and increasing, by said compressor, a pressure of said fed methane-containing gas;
feeding said increased pressurized methane-containing gas to a cooling unit for cooling said pressurized methane-containing gas;
decreasing said pressure of said pressurized and cooled methane-containing gas, thereby obtaining methane-containing liquid and flash-off gas;
feeding said methane-containing liquid and said flash-off gas to said container, wherein said flash-off gas is inputted into said container at or near a bottom part of said container for at least partly dissolving said flash-off gas into said methane-containing liquid. System for at least partially converting methane-containing gas, in particular boil-off gas, retained in a container, to a liquid state.

According to a first aspect the invention relates to a method for at least partially converting methane-containing gas, in particular boil-off gas, retained in a container, to a liquid state.

According to a second aspect the invention relates to a system for at least partially converting methane-containing gas, in particular boil-off gas, retained in a container, to a liquid state.

Methane-containing liquid such a Liquefied Natural Gas (LNG) can be retained in a container at temperatures in the range of −162 to −154 degrees Celcius at pressure levels of 0.3-1.0 barg. Due to heat input to the container the methane-containing liquid expands and a part of the methane-containing liquid will evaporate resulting in boil-off gas. This results in a pressure increase in the container. To reduce the pressure increase methods and systems are known to at least partially re-liquefy the boil-off gas or to remove the boil-off gas from the container. A known method to reduce the evaporation resulting in boil-off gas is to sub-cool the methane-containing liquid using liquid nitrogen. A drawback of sub-cooling using liquid nitrogen is a relative low energy efficiency.

An objective of the current invention is to provide an improved method to convert methane-containing gas, in particular boil-off gas, to a liquid state.

This objective is achieved with the method according to the first aspect of the current invention, the method comprising the subsequent steps of:
feeding methane-containing gas from said container to a compressor, and increasing, by said compressor, a pressure of said fed methane-containing gas,
feeding said increased pressurized methane-containing gas to a cooling unit for cooling said pressurized methane-containing gas;
decreasing said pressure of said pressurized and cooled methane-containing gas, thereby obtaining methane-containing liquid and flash-off gas;
feeding said methane-containing liquid and said flash-off gas to said container, wherein said flash-off gas is inputted into said container at or near a bottom part of said container for at least partly dissolving said flash-off gas into said methane-containing liquid.

The methane-containing gas is at least partly re-liquefied through compression, cooling and decreasing the pressure of the methane-containing gas to obtain methane-containing liquid and flash-off gas. By inputting at least the flash-off gas at or near a bottom part of the container into the container the flash-off gas remains relatively long in the methane-containing liquid before reaching a surface level of the methane-containing liquid in the container. A relative long residence time of the flash-off gas in the methane-containing liquid is advantageous for at least partly dissolving the flash-off gas in the methane-containing liquid thereby increasing the conversion of methane-containing gas to a liquid state.

A further advantage of the method according to the first aspect of the invention is a reduction of the change in composition of the methane-containing liquid retained in a container over time. A methane-containing liquid, such a LNG, may apart from methane for instance also comprise propane, ethane and nitrogen. The composition of LNG in a container using said known methods and systems will change in that the methane content and the nitrogen content in the boil-off gas will be relatively high compared to the propane and ethane content. Removing boil-off gas from the container will therefore result in a change in composition of the methane-containing liquid over time.

A yet further advantage of the method according to the first aspect of the invention is the absence of the need to apply a phase separator to separate the flash-off gas from the fraction of methane-containing liquid before feeding the methane-containing liquid to the container. This allows for a relative compact system compared to known systems using a known method to re-liquefy methane-containing gas. In addition, a phase separator requires the method to be a batch process, whereas without a phase separator the method allows for a continuous process.

It is advantageous if the method further comprises the step of:
exchanging heat in a heat exchanger via said heat exchanger between said methane-containing gas and said methane-containing liquid and said flash-off gas, wherein said methane-containing gas is fed to said heat exchanger before said step of feeding said methane-containing gas to said compressor, and wherein said methane-containing liquid and said flash-off gas are fed to said heat exchanger before said step of feeding said methane-containing liquid and said flash-off gas to said container.

This step of exchanging heat via the heat exchanger is advantageous to further cool the methane-containing liquid and flash-off gas using the relative cold methane-containing gas, in particular boil-off gas, without mixing the methane-containing gas with the methane containing liquid and the flash-off gas. Due to this further cooling dissolving flash-off gas into methane-containing liquid is improved.

According to an embodiment of the invention, the method further comprises the step of:
exchanging heat in a further heat exchanger via said further heat exchanger between said methane-containing gas and said pressurized methane-containing gas, wherein said methane-containing gas is fed to said further heat exchanger before said step of feeding said methane-containing gas to said compressor.

This step of exchanging heat via the further heat exchanger is advantageous to further cool the pressurized methane-containing gas using the relative cold methane-containing gas, in particular boil-off gas, without mixing the boil-off gas with the pressurized methane-containing gas. Due to this further cooling dissolving flash-off gas into methane-containing liquid is improved.

In an embodiment of the invention, the method further comprises the step of:
exchanging heat in a yet further heat exchanger via said yet further heat exchanger between said methane-containing gas and said pressurized and cooled methane-containing gas, wherein said methane-containing gas is fed to said yet further heat exchanger before said step of feeding said methane-containing gas to said compressor.

This step of exchanging heat via the yet further heat exchanger is advantageous to yet further cool said pressurized and cooled methane-containing gas using the relative cold methane-containing gas, in particular boil-off gas, without mixing the boil-off gas with said pressurized and cooled methane-containing gas. Due to this yet further cooling dissolving flash-off gas into methane-containing liquid is improved.

It is advantageous if during said step of feeding said increased pressurized methane-containing gas to said cooling unit for cooling said methane-containing gas, said methane-containing gas is brought at least partially in a liquid state and a methane-containing mixture is created, wherein during said step of decreasing said pressure of said pressurized and cooled methane-containing gas, the pressure of said methane-containing mixture is decreased. Bringing said methane-containing gas at least partially in a liquid state is beneficial to increase the conversion into a liquid state of the methane-containing gas. A further advantage of bringing said methane-containing gas in a liquid state is an increase of a heat exchange coefficient in said further heat exchanger.

In an embodiment of the method according to the first aspect of the invention, the method further comprises the step of feeding a further methane-containing gas to said compressor, wherein said methane-containing gas and said further methane-containing gas are pressurized during said step of feeding methane-containing gas to said compressor. Feeding a further methane-containing gas is advantageous as regards the utilization of available methane-containing gas, for instance from a local methane-containing gas producing facility.

In this regard it is advantageous if during said step of feeding said further methane-containing gas to said compressor the temperature of said further methane-containing gas is at a temperature above 0 degrees Celcius. A temperature above 0 degrees Celcius is advantageous to increase an average temperature of the methane-containing gas fed to compressor to increase the lifespan of the compressor. A further advantage is the reduced heat input to said container of said further methane-containing gas.

In an embodiment of the method according to the first aspect of the present invention said flash-off gas contains a first fraction of flash-off gas and a second fraction of flash-off gas, wherein said first fraction of flash-off gas is fed to said container and said second fraction is fed to a further container. Feeding said second fraction to a further container is beneficial to for instance provide a source of flash-off gas to a Compressed Natural Gas (CNG) compressor.

It is advantageous if said flash-off gas contains up to 20% nitrogen, preferably in the range of 12%-20% nitrogen. Nitrogen up to 20%, preferably in the range of 12% to 20% can be dissolved relatively well in said methane-containing liquid without significantly reducing operation of the method according to the first aspect.

In a practical embodiment of the method during said step of decreasing said pressure of said pressurized and cooled methane-containing gas, wherein said obtained methane-containing liquid and said obtained flash-off gas have a temperature lower than the temperature of said methane-containing gas retained in said container. This is beneficial to cool the contents of said container, thereby reducing expansion of methane-containing liquid and evaporation resulting in boil-off gas when methane-containing liquid is retained in said container.

According to a second aspect, the invention relates to a system for at least partially converting methane-containing gas, in particular boil-off gas, retained in a container, to a liquid state, the system comprising:
a compressor for increasing a pressure of said methane-containing gas, wherein said compressor is in fluid connection with said container;
a cooling unit for cooling said increased pressurized methane-containing gas, wherein said cooling unit is in fluid connection with said compressor;
a pressure decreasing means for decreasing said pressure of said pressurized and cooled methane-containing gas, to obtain methane-containing liquid and flash-off gas, wherein said pressure decreasing means are in fluid connection with said cooling unit;
a connection means for feeding said methane-containing liquid and said flash-off gas to said container, wherein said connection means are designed to feed said flash-off gas at or near a bottom part of said container to said container for at least partly dissolving said flash-off gas into said methane-containing liquid.

The advantages of the system according to the second aspect of the invention are analogue to the advantages of the method according to the first aspect of the invention.

Within the context of the invention fluid connection is an operative connection for fluid flow.

In a preferred embodiment the system further comprises:
a heat exchanger for exchanging heat via said heat exchanger between said methane-containing gas and said methane-containing liquid and said flash-off gas.

It is advantageous if the system further comprises a further heat exchanger for exchanging heat via said further heat exchanger between said methane-containing gas and said pressurized methane-containing gas.

In an embodiment the system comprises a yet further heat exchanger for exchanging heat via said yet further heat exchanger between said methane-containing gas and said pressurized and cooled methane-containing gas.

It is beneficial if said cooling unit comprises:
a cooling unit heat exchanger for exchanging heat via the cooling unit heat exchanger between a cooling medium and said pressurized methane-containing gas;
a cooling unit compressor for increasing a pressure of said cooling medium, wherein said cooling unit compressor is in fluid connection with said cooling unit heat exchanger;
a cooling medium pressure decreasing means for decreasing said pressure of said pressurized cooling medium to cool the cooling medium, wherein the cooling medium pressure decreasing means are in fluid connection with the cooling unit compressor and said cooling unit heat exchanger.

A cooling unit comprising a cooling unit heat exchanger, a cooling unit compressor and a cooling medium pressure decreasing means is advantageous for cooling exchanging heat between said methane-containing gas and said methane-containing liquid and said flash-off gas.

The present invention will now be explained by means of a description of preferred embodiments of a method and system according to the invention, in which reference is made to the following schematic figures, in which:

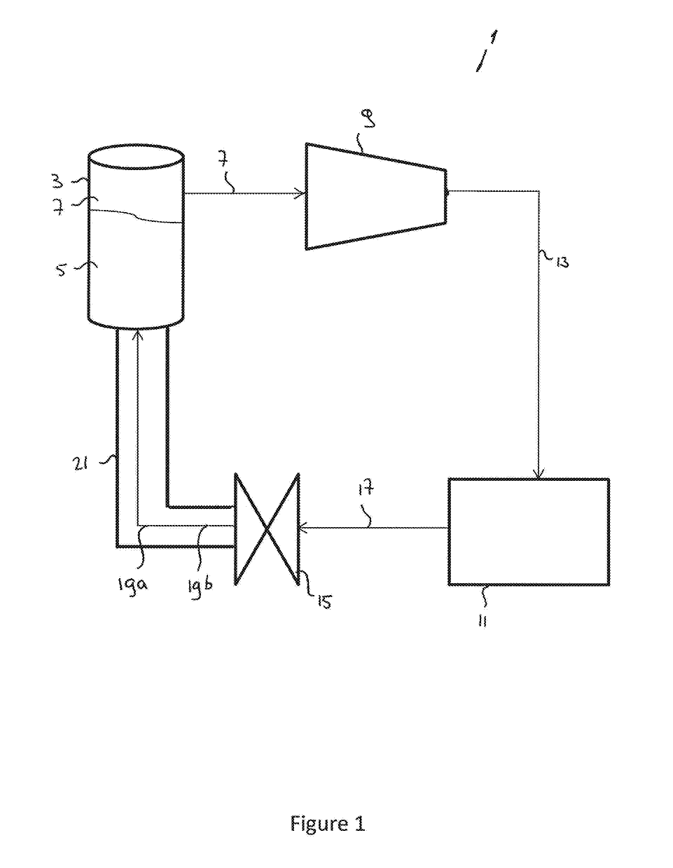

FIG. 1 is a preferred embodiment of a system according to the invention;

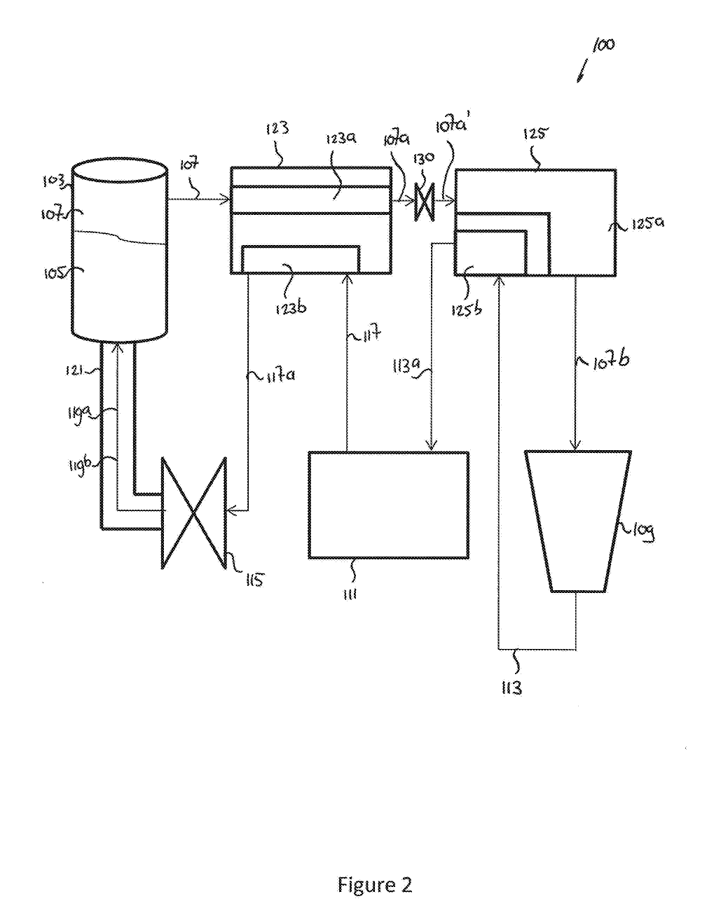

FIG. 2 is a further preferred embodiment of a system according to the invention.

System 1 for at least partially converting methane-containing gas to a liquid state is coupled to a container 3. Container 3 is designed to retain a methane-containing liquid 5 and a methane-containing gas 7 at a pressure in the range of 1-8 barg and a temperature in the range of −120 to −158 degrees Celcius. The container 3 is coupled with a compressor 9 of system 1. Compressor 9 is designed for increasing a pressure of said methane-containing gas 7 in a range of 100-125 barg, whereby the temperature of said pressurized methane containing gas is in the range of 5-45 degrees Celcius. A cooling unit 11 is in fluid connection with said compressor 9 for feeding pressurized methane-containing gas 13 to said cooling unit 11. The cooling unit 11 is designed to cool the methane-containing gas 13 down to a temperature in the range of −50 to to −85 degrees Celcius, whereby the pressure of the cooled and pressurized methane-containing gas is substantially equal to the pressure of said pressurized methane-containing gas 13. System 1 further comprises pressure decreasing means 15 in fluid connection with said cooling unit 11 for feeding pressurized and cooled methane-containing gas 17 to said pressure decreasing means 15. The pressure decreasing means 15 contain a pressure regulator such as for example a Joule-Thomson-valve for decreasing the pressure of said pressurized and cooled methane-containing gas 17 to a predetermined level in the range of 1.2-8.5 barg. The methane-containing liquid 19a and flash-off gas 19b obtained by decreasing said pressure of said pressurized and cooled-methane-containing gas 17 has a temperature in the range of −120 to −158 degrees Celcius and is fed to container 3 via connection means 21. The connection means 21 are connected to said container 3 at a bottom part of said container 3 for at least partly dissolving said flash-off gas 19b into said methane-containing liquid 5 and 19a.

In an embodiment of the method according to the first aspect of the invention the system 1 is in fluid connection with container 3 wherein LNG 5 and boil-off gas 7 are retained at a pressure of 3 barg at temperature of −140 degrees Celcius. The boil-off gas 7 contains 10% nitrogen. The boil-off gas 7 is fed at a rate of 23 kg/hour to compressor 9 and pressurized up to a pressure of 120 barg, thereby reaching a temperature of 40 degrees Celcius. The pressurized boil-off gas 13 is fed to a cooling unit 11. The cooling unit 11 cools the pressurized boil-off gas 13 down to a temperature of −80 degrees Celcius. The pressure decreasing means 15 reduce the pressure of the pressurized and cooled boil-off gas 17 to a pressure of 3.2 barg, thereby obtaining methane-containing liquid 19a at a rate of 13 kg/hour having a temperature of −142 degrees Celcius and flash-off gas 19b at a rate of 10 kg/hour having a temperature of −142 degrees Celcius. The methane-containing liquid 19a and flash-off gas 19b are fed from the pressure decreasing means 15 into the container 3 at a bottom part of the container 3 via connection means 21.

System 100 for at least partially converting methane-containing gas to a liquid state is coupled to a container 103. Container 103 is designed to retain a methane-containing liquid 105 and a methane-containing gas 107 at a pressure in the range of 1 to 8 barg and a temperature in the range of −120 to −158 degrees Celcius. Container 103 is coupled with a first chamber 123a of a first heat exchanger 123 of system 100. Said first heat exchanger 123 is designed for exchanging heat between said methane-containing gas 107 in the first chamber 123a and said pressurized and cooled methane-containing gas 117 in a second chamber 123b, wherein said methane-containing gas 107 and said pressurized and cooled methane-containing gas 117 remain separated from each other. The first heat exchanger 123 is designed to heat the boil-off gas 107 in the first chamber 123a of the first heat exchanger 123 to temperature in the range of −100 to −70 degrees Celcius. A first chamber 125a of a second heat exchanger 125 is in fluid connection with the first chamber 123a of the first heat exchanger 123, wherein a pressure reducer 130 is provided between the first chamber 125a of the second heat exchanger 125 and the first chamber 123a of the first heat exchanger 123 to reduce the pressure of methane-containing gas 107a outputted from the first chamber 123a of the first heat exchanger 123 to a pressure in the range of 0.1-0.5 barg. Said second heat exchanger 125 is designed for exchanging heat between methane-containing gas 107a′ outputted from the pressure reducer 130 and pressurized methane-containing gas 113 outputted from a compressor 109 and fed into a second chamber 125b of the second heat exchanger 125. The second heat exchanger 125 is designed to heat the boil-off gas 107a′ in the first chamber 125a of the second heat exchanger 125 to temperature in the range of −5 to 25 degrees Celcius. Compressor 109 is in fluid connection with the first chamber 125a of the second heat exchanger 125 for receiving methane-containing gas 107b outputted from the first chamber 125a of the second heat exchanger 125. Compressor 109 is designed for increasing a pressure of said methane-containing gas 107b to a pressure in the range of 100-125 barg. Pressurized methane-containing gas 113 outputted from said compressor 109 can be fed into said second chamber 125b of said second heat exchanger 125 via a fluid connection between said compressor 109 and said second chamber 125b of said second heat exchanger 125. Said second chamber 125b of said second heat exchanger 125 is in fluid connection with a cooling unit 111 for feeding pressurized methane-containing gas 113a to the cooling unit 111. The cooling unit 111 is designed to cool pressurized methane-containing gas 113a down to a temperature in the range of −50 to −80 degrees Celcius. Cooled and pressurized methane-containing gas 117 outputted from the cooling unit 111 can be fed to the second chamber 123b of said first heat exchanger 123 via a fluid connection between said cooling unit 111 and said second chamber 123b of said first heat exchanger 123. Said second chamber 123b of said first heat exchanger 123 is in fluid connection with pressure decreasing means 115 for feeding pressurized and cooled methane-containing gas 117a to said pressure decreasing means 115. The pressure decreasing means 115 contain a pressure regulator such as for example a Joule-Thomson-valve for decreasing the pressure of said pressurized and cooled methane-containing gas 117a to a predetermined level in the range of 1.2-8.5 barg. The methane-containing liquid 119a and flash-off gas 119b obtained by decreasing said pressure of said pressurized and cooled-methane-containing gas 117a can be fed to container 103 via connection means 121. The connection means 121 are connected to said container 103 at or near a bottom part of said container 103 for at least partly dissolving said flash-off gas 119b into said methane-containing liquid 105 and 119a.

In an embodiment of the method according to the first aspect of the invention the system 100 is in fluid connection with container 103 wherein LNG 105 and boil-off gas 107 are retained at a pressure of 3 barg at temperature of −140 degrees Celcius. The boil-off gas 107 contains 10% nitrogen. The boil-off gas 107 is fed at a rate of 23 kg/hour to a first chamber 123a of a first heat exchanger 123. The boil-off gas 107a is outputted from this first chamber 123a of the first heat exchanger 123 at a temperature of −85 degrees Celcius at a pressure of 2.8 barg. The boil-off gas 107a outputted from the first chamber 123a of the first heat exchanger 123 is fed to a pressure reducer 130 to reduce the pressure of the methane-containing gas 107a′ to a pressure of 0.2 barg. Subsequently the boil-off gas 107a′ outputted from the pressure reducer 130 is fed to a first chamber 125a of a second heat exchanger 125. The boil-off gas 107b is outputted from the first chamber 125a of the second heat exchanger 125 at a temperature of 20 degrees Celcius at a pressure of substantially 0.2 barg. Boil-off gas 107b is fed to compressor 109 and pressurized to a pressure of 120 barg, thereby obtaining a temperature of 30 degrees Celcius. Pressurized boil-off gas 113 is fed to a second chamber 125b of the second heat exchanger 125 for exchanging heat via the second heat exchanger 125 with the boil-off gas 107a′. Pressurized boil-off gas 113a is outputted from the second chamber 125b of the second heat exchanger 125 at a temperature of −20 degrees Celcius. The pressurized boil-off gas 113a is fed to cooling unit 111. The cooling unit 111 cools the pressurized boil-off gas 113a down to a temperature of −70 degrees Celcius. The cooled and pressurized boil-off gas 117 outputted from the cooling unit 111 is fed to the second chamber 123b of the first heat exchanger 123 for exchanging heat via the first heat exchanger 123 with the boil-off gas 107. Cooled and pressurized boil-off gas 117a is outputted from the second chamber 123b of the first heat exchanger 123 at a temperature of −100 degrees Celcius, wherein the cooled and pressurized boil-off gas 117a is in a two-phase vapour-liquid state. The pressure decreasing means 115 reduce the pressure of the pressurized and cooled boil-off gas 117a to a pressure of 3.2 barg, thereby obtaining methane-containing liquid 119a having a temperature of −142 degrees Celcius at a rate of 13 kg/hour and flash-off gas 119b having a temperature of −142 degrees Celcius at a rate of 10 kg/hour. The methane-containing liquid 119a and flash-off gas 119b are fed from the pressure decreasing means 115 into the container 103 at a bottom part of the container 103 via connection means 121.

1. A method for at least partially converting methane-containing gas, retained in a container, to a liquid state, the method comprising the steps of:
feeding methane-containing gas from said container to a compressor, and increasing, by said compressor, a pressure of said fed methane-containing gas;
feeding said increased pressurized methane-containing gas to a cooling unit for cooling said pressurized methane-containing gas;
decreasing said pressure of said pressurized and cooled methane-containing gas, thereby obtaining methane-containing liquid and flash-off gas;
feeding said methane-containing liquid and said flash-off gas to said container, wherein said flash-off gas is inputted into said container at or near a bottom part of said container for at least partly dissolving said flash-off gas into said methane-containing liquid.

2. The method according to claim 1, further comprising the step of:
exchanging heat in a heat exchanger via said heat exchanger between said methane-containing gas and said methane-containing liquid and said flash-off gas, wherein said methane-containing gas is fed to said heat exchanger before said step of feeding said methane-containing gas to said compressor, and wherein said methane-containing liquid and said flash-off gas are fed to said heat exchanger before said step of feeding said methane-containing liquid and said flash-off gas to said container.

3. The method according to claim 1, further comprising the step of:
exchanging heat in a further heat exchanger via said further heat exchanger between said methane-containing gas and said pressurized methane-containing gas, wherein said methane-containing gas is fed to said further heat exchanger before said step of feeding said methane-containing gas to said compressor.

4. The method according to claim 1, further comprising the step of:
exchanging heat in a yet further heat exchanger via said yet further heat exchanger between said methane-containing gas and said pressurized and cooled methane-containing gas, wherein said methane-containing gas is fed to said yet further heat exchanger before said step of feeding said methane-containing gas to said compressor.

5. The method according to claim 1, wherein during said step of feeding said increased pressurized methane-containing gas to said cooling unit for cooling said methane-containing gas, said methane-containing gas is brought at least partially in a liquid state and a methane-containing mixture is created, wherein during said step of decreasing said pressure of said pressurized and cooled methane-containing gas, the pressure of said methane-containing mixture is decreased.

6. The method according to claim 1, further comprising the step of feeding a further methane-containing gas to said compressor, wherein said methane-containing gas and said further methane-containing gas are pressurized during said step of feeding methane-containing gas to said compressor.

7. The method according to claim 6, wherein before said step of feeding said further methane-containing gas to said compressor the temperature of said further methane-containing gas is at a temperature above 0 degrees Celsius.

8. The method according to claim 1, wherein said flash-off gas contains a first fraction of flash-off gas and a second fraction of flash-off gas, wherein said first fraction of flash-off gas is fed to said container and said second fraction is fed to a further container.

9. The method according to claim 1, wherein said flash-off gas contains up to 20% nitrogen, preferably in the range of 12% to 20% nitrogen.

10. The method according to claim 1, wherein during said step of decreasing said pressure of said pressurized and cooled methane-containing gas, wherein said obtained methane-containing liquid and said obtained flash-off gas have a temperature lower than the temperature of said methane-containing gas retained in said container.

11. A system for at least partially converting methane-containing gas, retained in a container, to a liquid state, the system comprising:
a compressor for increasing a pressure of said methane-containing gas, wherein said compressor is in fluid connection with said container;
a cooling unit for cooling said increased pressurized methane-containing gas, wherein said cooling unit is in fluid connection with said compressor;
a pressure decreasing means for decreasing said pressure of said pressurized and cooled methane-containing gas, to obtain methane-containing liquid and flash-off gas, wherein said pressure decreasing means are in fluid connection with said cooling unit;
a connection means for feeding said methane-containing liquid and said flash-off gas to said container, wherein said connection means are designed to feed said flash-off gas at or near a bottom part of said container to said container for at least partly dissolving said flash-off gas into said methane-containing liquid.

12. The system according to claim 11, wherein the system further comprises:
a heat exchanger for exchanging heat via said heat exchanger between said methane-containing gas and said methane-containing liquid and said flash-off gas.

13. The system according to claim 11, wherein the system further comprises a further heat exchanger for exchanging heat via said further heat exchanger between said methane-containing gas and said pressurized methane-containing gas.

14. The system according to claim 11, wherein the system further comprises a yet further heat exchanger for exchanging heat via said yet further heat exchanger between said methane-containing gas and said pressurized and cooled methane-containing gas.

15. The system according to claim 11, wherein said cooling unit comprises:
a cooling unit heat exchanger for exchanging heat via the cooling unit heat exchanger between a cooling medium and said pressurized methane-containing gas;
a cooling unit compressor for increasing a pressure of said cooling medium, wherein said cooling unit compressor is in fluid connection with said cooling unit heat exchanger;
a cooling medium pressure decreasing means for decreasing said pressure of said pressurized cooling medium to cool the cooling medium, wherein the cooling medium pressure decreasing means are in fluid connection with the cooling unit compressor and said cooling unit heat exchanger.
